(19) United States
(12) Patent Application Publication
(10) Pub. No.: US 2013/0027549 A1
(43) Pub. Date: Jan. 31, 2013

(54) METHOD AND DEVICE FOR VIDEO SURVEILLANCE

(71) Applicants: Ruben Heras Evangelio, Berlin (DE); Thomas Sikora, Berlin (DE); Ivo Keller, Potsdam (DE)

(72) Inventors: Ruben Heras Evangelio, Berlin (DE); Thomas Sikora, Berlin (DE); Ivo Keller, Potsdam (DE)

(73) Assignee: TECHNISCHE UNIVERSITAT BERLIN, Berlin (DE)

(21) Appl. No.: 13/194,711

(22) Filed: Jul. 29, 2011

(51) Int. Cl. H04N 7/18

(52) U.S. Cl. 348/143; 348/E07.085

(57) ABSTRACT

The invention relates to a method and a device for video surveillance, wherein by means of at least one video camera, an image of an image excerpt of an environment to be monitored in the vicinity of the video camera is recorded, wherein at least one pixel of a short-term background model assigned to the image excerpt is compared at a first point in time with a corresponding pixel of a long-term background model assigned to the image excerpt at the first point in time and with a corresponding pixel of the long-term background model at a second point in time, wherein the second point in time precedes the first point in time.

### BACKGROUND AND SUMMARY

The invention relates to a method and a device for video surveillance, wherein, by means of a video camera, an image of an environment to be monitored in the vicinity of the video camera is recorded.

EP 1 077 397 A1 discloses a method and a device for the video surveillance of process installations. In that case, a stored first reference image is compared with a first comparison image recorded by a video camera, and an alarm signal is output if the number of differing pixel values is greater than a predetermined threshold value. Furthermore, a second threshold value is provided, which is less than the first threshold value. If the number of differing pixel values lies between these two threshold values, then the associated comparison image is stored as a further reference image and used for subsequent comparisons with newly recorded comparison images.

WO 98/40855 A1 discloses a device for the video surveillance of an area with a video camera, which optically captures the area from a specific viewing angle, and an evaluation device, wherein video means for optically capturing the same area from a different viewing angle are provided and the evaluation device is suitable for processing the stereoscopic video information originating from the two viewing directions to form three-dimensional video image signal sets and for comparing the latter with corresponding reference signal sets of a three-dimensional reference model.

U.S. Pat. No. 5,684,898 discloses a method and a device for generating a background image from a plurality of images of a scene and for subtracting a background image from an input image. In order to generate a background image, an image is divided into partial images in order to obtain reference partial images for each position of a partial image, wherein successive partial images are compared with the reference partial image in order to recognize objects between the reference partial image and a video camera that has recorded the image.

Some known methods for detecting static objects in video sequences are based on the combination of background subtraction methods with tracking information, so-called tracking (cf. Bayona, Álvaro, San Miguel, Juan Carlos and Martinez Sánchez, Jose Maria. Comparative Evaluation of Stationary Foreground Object Detection Algorithms Based on Background Subtraction Techniques. Proceedings of the IEEE International Conference on Advanced Video and Signal Based Surveillance. 2009, pages 25-30; Guler, S., Silverstein, J. A. and Pushee, L H. Stationary objects in multiple object tracking. Proceedings of the IEEE. International Conference on Advanced Video and Signal Based Surveillance. 2007, 5.248-253; 3. Singh, A., et al. An Abandoned Object Detection System Based on Dual Background Segmentation. Proceedings of the IEEE International Conference on Advanced Video and Signal Based Surveillance. 2009, pages 352-357 and Venetianer, P. L., et al. Stationary target detection using the object video surveillance system. Proceedings of the IEEE International Conference on Advanced Video and Signal Based Surveillance, 2007, pages 242-247).

As an alternative to the use of tracking information, use is made of dual background subtraction methods (cf. Porikli, Fatih, Ivanov, Yuri and Haga, Tetsuji: Robust abandoned object detection using dual foregrounds; EURASIP J. Adv. Signal Process. 2008) and methods which interpret the results of a background basic subtraction (cf. Tian, Y., Feris, R. S. and Hampapur, A.: Real-Time Detection of Abandoned and Removed Objects in Complex Environments; Proceedings of the IEEE International Workshop on Visual Surveillance; 2008).

It is an object of the invention to improve video surveillance, or make it more robust, particularly with regard to the recognition of static objects. It is an object of the invention, in particular, to provide video surveillance for recognizing static objects with a high degree of recognition certainty in conjunction with a lower false alarm rate. It is desirable, in particular, to provide video surveillance for recognizing static objects which is suitable particularly for situations with a high proportion of non-static objects. It is desirable, in particular, to provide video surveillance for recognizing static objects which is particularly suitable for airports and stations.

The abovementioned object is achieved by means of a method for video surveillance, in particular for recognizing static objects, such as suitcases or bags that have been left, for example, wherein, by means of at least one video camera, an image of an image excerpt of an environment to be monitored in the vicinity of the video camera is recorded, wherein at least one pixel of a short-term background model assigned to the image excerpt is compared at a first point in time with a corresponding pixel of a long-term background model assigned to the image excerpt at the first point in time and with a corresponding pixel of the long-term background model at a second point in time, wherein the second point in time precedes the first point in time.

An image excerpt within the meaning of the invention is, in particular, the area which is captured by the video camera. An image excerpt within the meaning of the invention is, in particular, that part of the surroundings of the video camera which is imaged by means of the image.

A pixel within the meaning of the invention is, in particular, one pixel. However, a pixel within the meaning of the invention can also comprise or be a group of pixels.

A background model can be, for example, a background model in accordance with U.S. Pat. No. 5,684,898. Background models can be generated for example in accordance with the methods described in the article by Stauffer, Chris and Crimson, W. E. L.: Adaptive background mixture models for real-time tracking; Proceedings of the IEEE Conference on Computer Vision and Pattern Recognition; 1999, wherein any model that can model a multimodal density distribution (cf., for example, Zivkovic: Improved adaptive Gaussian mixture model for background subtraction; Proceedings of the International Conference on Pattern Recognition; 2004) can be used. A background model within the meaning of the invention is, in particular, a model of the statistical components of the image which is recorded by the video camera. A background model within the meaning of the invention is, in particular, an image or image model reduced by the dynamic components of the image recorded by means of the video camera. A short-term background model within the meaning of the invention includes, in particular, pixels that have remained static for a first time interval in the image recorded by the video camera. A long-term background model within the meaning of the invention includes, in particular, pixels that have remained static for a second time interval in the image recorded by the video camera. A second time interval within the meaning of the invention is longer, in particular approximately ten times longer, than a first time interval within the meaning of the invention.

A first point in time within the meaning of the invention is, in particular, a current point in time. A second point in time within the meaning of the invention is, in particular, a point in time before the first point in time at which a pixel of the long-term background model changed its properties or color. A color within the meaning of the invention can be, in particular, a color in the stricter sense, but also a brightness value. The second point in time within the meaning of the invention is, in particular, a different point in time for different pixels.

Two pixels are designated as corresponding within the meaning of the invention in particular when they have the same coordinates or lie at the same location.

A comparison of background models within the meaning of the invention also encompasses a comparison of variables derived from the background models, such as e.g. of foreground masks.

In an advantageous configuration of the invention, the pixel is assigned to an object added to the environment if the pixel of the short-term background model at the first point in time differs both from the corresponding pixel of the long-term background model at the first point in time and from the corresponding pixel of the long-term background model at the second point in time.

It is provided, in particular, that, in the case of such an assignment, an alarm, a message or a hazard warning message is generated or output. This can be effected optically and/or acoustically, for example. In a furthermore advantageous configuration of the invention, it is provided that the corresponding assignment is cancelled if the corresponding pixel of the image corresponds to the corresponding pixel of the long-term background model at the second point in time.

The abovementioned object is additionally achieved by means of a method for video surveillance, in particular for recognizing static objects, such as suitcases or bags that have been left, for example, wherein, by means of at least one video camera, an image of an image excerpt of an environment to be monitored in the vicinity of the video camera is recorded, wherein at least one pixel is assigned to a static object added to the environment if a corresponding pixel of a short-term background model assigned to the image excerpt at a first point in time differs both from a corresponding pixel of a long-term background model assigned to the image excerpt at the first point in time and from the corresponding pixel of the long-term background model at a second point in time, wherein the second point in time precedes the first point in time. A corresponding comparison of background models can be effected by means of variables derived from the background models, such as e.g. of foreground masks.

In a furthermore advantageous configuration of the invention, a short-term foreground mask is generated depending on the image and the short-term background model. It is provided, in particular, that the short-term background model is adapted by means of the short-term foreground mask. A short-term foreground mask is, in particular, that portion of the image which is reduced by the pixels which are identical to their corresponding pixels of the short-term background model.

In a furthermore advantageous configuration of the invention, a long-term foreground mask is generated depending on the image and the long-term background model. It is provided, in particular, that the long-term background model is adapted by means of the long-term foreground mask. A long-term foreground mask is, in particular, that portion of the image which is reduced by the pixels which are identical to their corresponding pixels of the long-term background model. Foreground masks are obtained, in particular, by means of so-called background subtractions. Details concerning background subtraction are disclosed, for example, in the article Karaman, Mustafa, et al. Comparison of Static Background Segmentation Methods. Visual Communications and Image Processing (VCIP 05). 2005 and the article Karaman, Mustafa, Goldmann, Lutz and Sikora, Thomas. A New Segmentation Approach Using Gaussian Color Model and Temporal Information. Visual Communications and Image Processing (VCIP), IS&T/SPIE's Electronic Imaging, 2006.

In a furthermore advantageous configuration of the invention, the short-term foreground mask and/or the long-term foreground mask are/is fed to a finite state machine.

The abovementioned object is achieved—in particular in conjunction with features mentioned above—additionally by means of a device for video surveillance, in particular for recognizing static objects, such as suitcases or bags that have been left, for example, wherein the device for video surveillance comprises at least one video camera for recording an image of an image excerpt of an environment to be monitored in the vicinity of the video camera, a short-term background model assigned to the image excerpt, a long-term background model assigned to the image excerpt, and also an evaluation device, wherein a pixel can be assigned to a static object added to the environment by means of the evaluation device if a corresponding pixel of the short-term background model at a first point in time differs both from a corresponding pixel of the long-term background model at the first point in time and from the corresponding pixel of the long-term background model at a second point in time, wherein the second point in time precedes the first point in time. In this case, it can be provided that the short-term background model and/or the long-term background model are part of the evaluation device. In an advantageous configuration of the invention, the evaluation device comprises a finite state machine.

The invention makes it possible to recognize static objects without using tracking information. The background models are not selectively updated, and possible incorrect decisions in the models are not adopted. Static objects are nevertheless detected further, even if they have been simultaneously learned by the long-term background model. By means of the state machine, the system can be used totally autonomously or else in an interactive manner. Consequently, an operator can correct possible incorrect decisions, without the underlying model having to be modified.

### BRIEF DESCRIPTION OF THE DRAWINGS

Further advantages and details will become apparent from the following description of exemplary embodiments. In this case, in the figures:

FIG. 1 shows an exemplary embodiment of a device for video surveillance;

FIG. 2 shows an exemplary embodiment of an evaluation device;

FIG. 3 shows an exemplary embodiment of a finite state machine;

FIG. 4 shows various exemplary images; and

FIG. 5 shows an extension of the finite state machine in accordance with FIG. 3.

### DETAILED DESCRIPTION

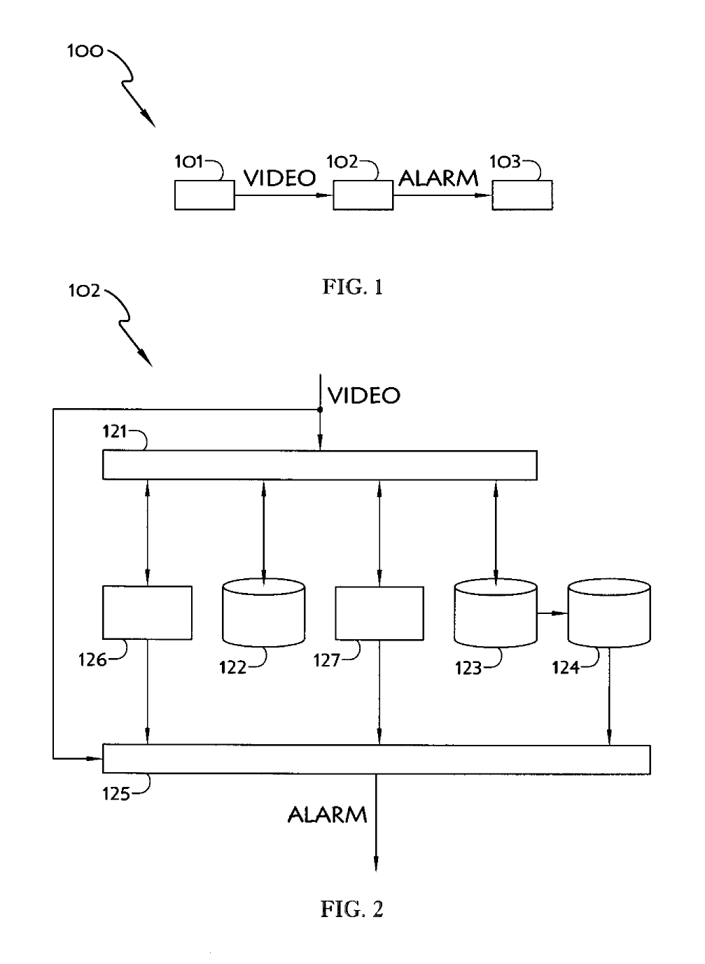

FIG. 1 shows an exemplary embodiment of a device 100 for video surveillance, comprising a video camera 101 for recording an image VIDEO of an image excerpt in an environment to be monitored in the vicinity of the video camera 101. The image VIDEO is analyzed by means of an evaluation device 102 in order to recognize static objects such as, for example, bags or suitcases left at an airport or station. If the evaluation device 102 recognizes a static object in the image VIDEO, then it outputs a corresponding message ALARM to an output device 103.

The evaluation device 102 comprises—as illustrated in FIG. 2—a model updating module 121 for updating or generating a short-term background model 122 and a long-term background model 123. The short-term background model 122 and the long-term background model 123 are updated in different time intervals (dual background subtraction). By means of the short-term background model 122, a short-term foreground mask is generated for each frame (corresponds to image VIDEO) of a video sequence. By means of the long-term background model 122, a long-term foreground mask is generated for each frame (corresponds to image VIDEO) of a video sequence.

After an initialization phase in which the short-term background model 122 and the long-term background model 123 have been set up, a short-term foreground mask 126 and a long-term foreground mask 127 are calculated for each new frame a video frequency, that is to say for each new image VIDEO. In addition, the short-term background model 122 and the long-term background model 123 are updated. If a pixel is updated in the context of this updating of the long-term background model 123, then the old state of said pixel is archived in an archive model 124. The archive model 124 is therefore a background model whose pixels respectively reflect a corresponding pixel of the long-term background model 123 before updating of the corresponding pixel.

The evaluation device 102 additionally comprises an evaluation module 125 with a finite state machine, wherein the short-term foreground mask 126 and the long-term foreground mask 127 are input variables of the finite state machine. The state machine interprets the results of the background subtraction on the basis of the pixel history in the archive model 124. As a result, it is possible to detect a pixel as part of a static object, without having to carry out selective updating of the long-term background model 123.

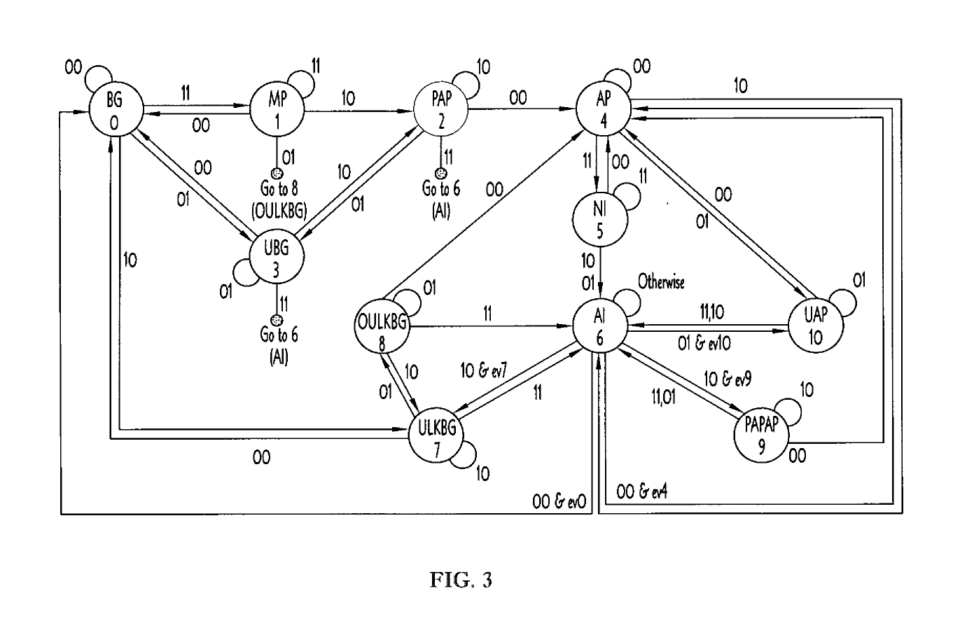

FIG. 3 shows the states of the state machine with English abbreviations describing the meaning of each state. The abbreviations stand for:
state 0, BG: background, a pixel which belongs to the background of the scene.
state 1, MP: moving pixel, a pixel which belongs to a moving object.
state 2, PAP: partially absorbed pixel, a pixel which belongs to an object which is already contained in the short-term background model, but is not yet contained in the long-term background model.
state 3, UBG: uncovered background, a pixel which belongs to a region which had already been learned by the short-term background model, but where now the background of the scene is visible again.
state 4, AP: absorbed pixel, a pixel which belongs to an object which has already been learned by both background models.
state 5, NI: new indetermination, a pixel which cannot be unambiguously clarified on the basis of the background models, even though the background models have the state 4 AP. It is not possible to decide whether “forgotten” background or a former object is involved.
state 6, AI: absorbed indetermination, a pixel which can be clarified on the basis of the short-term background model, but not on the basis of the long-term background model. This is an indetermination that is solved by a coordinating method.
state 7, ULKBG: uncovered last known background, a pixel which belonged to a former static object (AP state), but which now belongs to the background again.
state 8, OULKBG: occluded uncovered last known background, a pixel which belongs to an object which is situated perspectively in front of a ULKBG region.
state 9, PAPAP: partially absorbed pixel over absorbed pixel, a pixel which belongs to an object which is situated perspectively in front of a static object in the AP state.
state 10, UAP: uncovered absorbed pixel, a pixel which belongs to a static object which was perspectively occluded for a time.

In this case, the assignment to a state is effected, in particular, depending on the preceding state.

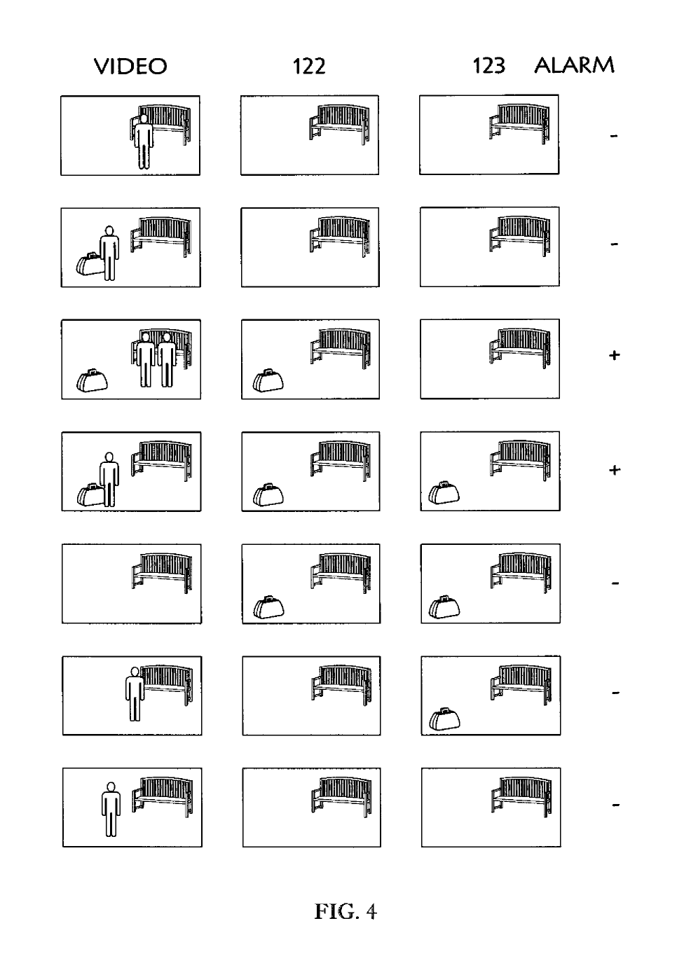

FIG. 4 illustrates the node of operation of the evaluation module 125 or of the state machine on the basis of a simplified example, wherein the first column designates the image VIDEO, the second column designates the content of the short-term background model 122, and the right-hand column designates the content of the long-term background model 123. Illustrated on the right next to the right-hand column are plus and minus, which designate the status of the message ALARM. A minus symbolizes that no hazard warning message is output, whereas a plus symbolizes that a hazard warning message is output. The rows designate different points in time, where more recent points in time are arranged below older points in time.

In the second row it can be discerned that a travelling bag is imaged in the image VIDEO. Said travelling bag has been left, and so it also appears again in the later image VIDEO (c.f. row 3). After a first time interval has elapsed, the travelling bag is included in the short-term background model 122. Since the short-term background model 122 and the long-term background model 123 correspondingly differ by the image of the travelling bag, the latter is recognized as an added static object and a corresponding message is output (cf. row 3).

As can be discerned in the 4th row, the travelling bag remains for longer than a second time interval, and so its image is also included in the long-term background model 123.

Row 5 illustrates a situation in which the travelling bag has been removed and is no longer visible in the image VIDEO. This is assessed as removal of the static object, and the message ALARM is set accordingly. After the first time interval has elapsed, the removal of the travelling bag is recognized as a static change and the short-term background model 122 is correspondingly corrected (cf. 6th row). The comparison with the long-term background model 123 yields a static change which a conventional system without tracking could not distinguish from a situation in which an object has been added. With the comparison of the corresponding pixels of the long-term background model 123 before updating (cf. right-hand column, rows 1 to 3), the evaluation module 125 recognizes that the static change is based on the removal of the travelling bag and not on the addition of an additional object. Accordingly, no message is output. After a second time interval has elapsed, the image of the travelling bag is also removed in the long-term background model 123 (cf. row 7).

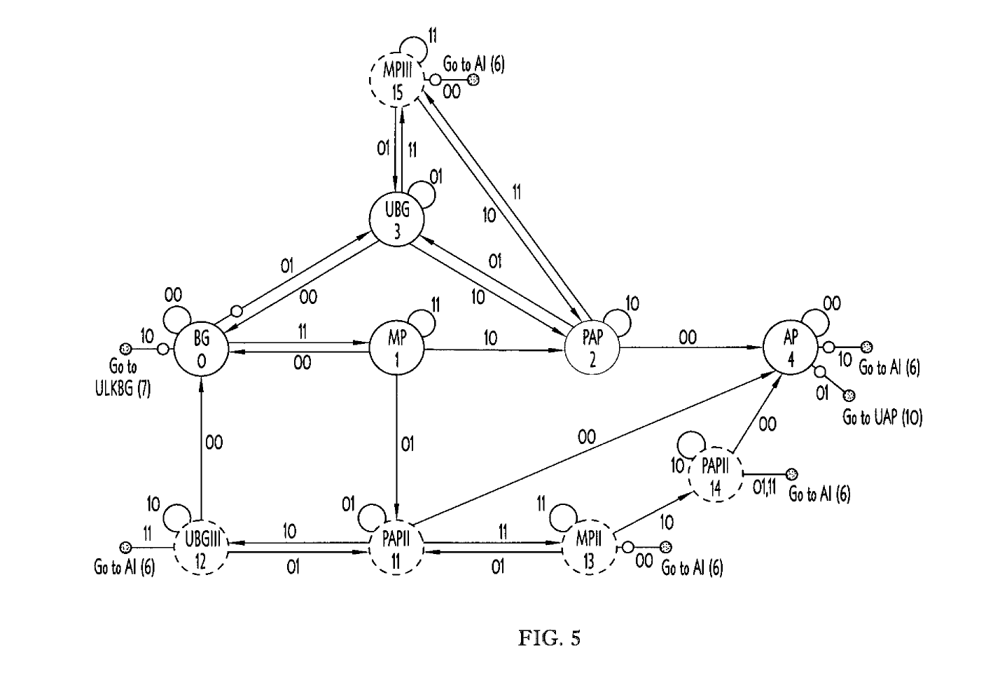

FIG. 5 shows an extension of the finite state machine by known sequences.

1. Method for video surveillance, wherein, by means of at least one video camera, an image of an image excerpt of an environment to be monitored in the vicinity of the video camera is recorded, wherein at least one pixel of a short-term background model assigned to the image excerpt is compared at a first point in time with a corresponding pixel of a long-term background model assigned to the image excerpt at the first point in time and with a corresponding pixel of the long-term background model at a second point in time, wherein the second point in time precedes the first point in time.

2. Method according to claim 1, wherein the pixel is assigned to an object added to the environment if the pixel of the short-term background model at the first point in time differs both from the corresponding pixel of the long-term background model at the first point in time and from the corresponding pixel of the long-term background model at the second point in time.

3. Method according to claim 2, wherein a short-term foreground mask is generated depending on the image and the short-term background model.

4. Method according to claim 3, wherein the short-term foreground mask is fed to a finite state machine.

5. Method according to claim 2, wherein a long-term foreground mask is generated depending on the image and the long-term background model.

6. Method according to claim 5, wherein the long-term foreground mask is fed to a finite state machine.

7. Method for video surveillance, wherein, by means of at least one video camera, an image of an image excerpt of an environment to be monitored in the vicinity of the video camera is recorded, wherein at least one pixel is assigned to a static object added to the environment if a corresponding pixel of a short-term background model assigned to the image excerpt at a first point in time differs both from a corresponding pixel of a long-term background model assigned to the image excerpt at the first point in time and from the corresponding pixel of the long-term background model at a second point in time, wherein the second point in time precedes the first point in time.

8. Method according to claim 7, wherein a short-term foreground mask is generated depending on the image and the short-term background model.

9. Method according to claim 8, wherein the short-term foreground mask is fed to a finite state machine.

10. Method according to claim 7, wherein a long-term foreground mask is generated depending on the image and the long-term background model.

11. Method according to claim 10, wherein the long-term foreground mask is fed to a finite state machine.

12. Device for video surveillance, wherein the device for video surveillance comprises at least one video camera for recording an image of an image excerpt of an environment to be monitored in the vicinity of the video camera, a short-term background model assigned to the image excerpt, a long-term background model assigned to the image excerpt, and also an evaluation device, wherein a pixel can be assigned to a static object added to the environment by means of the evaluation device if a corresponding pixel of the short-term background model at a first point in time differs both from a corresponding pixel of the long-term background model at the first point in time and from the corresponding pixel of the long-term background model at a second point in time, wherein the second point in time precedes the first point in time.

13. Device according to claim 12, wherein the evaluation device comprises a finite state machine.
